(19) United States
(12) Patent Application Publication
(10) Pub. No.: US 2005/0078029 A1
(43) Pub. Date: Apr. 14, 2005

(54) Two-frequency Doppler distance measuring apparatus and detection system having the apparatus

(75) Inventors: Shinichiro Okamura, Kyoto (JP); Takehiro Kawai, Muko-shi (JP); Keisuke Saito, Nara-shi (JP)

Correspondence Address: OSHA & MAY L.L.P., 1221 MCKINNEY STREET, SUITE 2800, HOUSTON, TX, 77010, US

(73) Assignee: OMRON Corporation, Kyoto-shi (JP)

(21) Appl. No.: 10/938,757

(22) Filed: Sep. 10, 2004

(30) Foreign Application Priority Data
Sep. 12, 2003 (JP) 2003-321832

(51) Int. Cl. G01S 13/58

(52) U.S. Cl. 342/28; 342/109; 342/111; 342/114; 342/115; 342/192

(57) ABSTRACT

A technique is disclosed for accurate measurement of the distance and detection of an object such as a human body behaving in a complicated way and having a complicated reflection surface using the two-frequency Doppler method. Each of the two-frequency Doppler signals is subjected to the short time Fourier transform to produce a spectrum in a short time window. Based on restraints, it is determined whether the waveforms of the two spectra are analogous to each other or not, and only in the case where the waveforms are analogous, the Doppler signals of the particular time window are used for distance calculation. As a result, the Doppler signals having the phase information low in reliability are eliminated, and therefore high-accuracy distance measurement and object detection are possible.

### BACKGROUND OF THE INVENTION

1. Field of the Invention

The present invention relates to a technique for measuring the distance to a reflection object using a two-frequency Doppler signal.

2. Description of the Related Art

The Doppler effect is a phenomenon in which when a wave source and a reflection object move relatively to each other, the frequencies of the wave transmitted from the wave source and the wave reflected on the object undergo change. In the case where the wave source and the object approach each other, the frequency is increased, and vice versa. An apparatus utilizing this phenomenon is a Doppler sensor which is used to detect the presence or absence of a moving object and detect the moving speed of the object.

The two-frequency Doppler sensor (two-frequency Doppler distance measuring apparatus) includes double Doppler modules for Doppler measurement. The modules each generate a Doppler signal individually using the continuous wave of different frequencies ft1, ft2. The phase difference between the two Doppler signal waveforms increases in proportion to the propagation distance of the wave, and therefore the distance between the apparatus and an object can be measured by observing the phase difference.

FIG. 14 shows a time waveform of the Doppler signal obtained in an ideal measurement environment. Let T be the period of the Doppler signal and τ the phase difference (time difference) between the two Doppler signals. The target distance 1 is determined by the equation shown below, where c is the velocity of light.

$$l = \frac{c}{2 ( {f}_{t1} - {f}_{t2} )} \cdot \frac{τ}{T} \qquad ( 1 )$$

The conventional sensor of this type is used as an on-vehicle sensor mainly to measure the distance to a car running immediately ahead or detect an obstacle (Japanese Unexamined Patent Publication No. 8-166443) and has never been used for the detection of a human body.

The speed of the automotive vehicle changes monotonically, and the reflection surface of an adjacent vehicle or an obstacle constituting a reflection object is often simple in shape. For the in-vehicle sensor, therefore, a comparatively simple waveform of the Doppler signal as shown in FIG. 15 is observed and the distance can be measured with high accuracy.

The behavior of a human body, in contrast, is so complicated that the speed may change sharply in any of longitudinal and lateral directions. Also, a moving direction (speed component) of each body part often differs from other parts′. Further, the human body has a so complicated shape that it has no uniform reflection surface. In the case where a human body is a target, therefore, a combined wave of a great variety of frequencies is observed, and as shown in FIG. 16, the Doppler signal waveform is irregular. The simple analysis of the time waveform as in the prior art, therefore, cannot obtain an accurate distance measurement.

### SUMMARY OF THE INVENTION

The present invention has been achieved in view of the situation described above, and the object thereof is to provide a technique for measuring and detecting the distance of an object such as a human body having a complicated behavior and reflection surface using the two-frequency Doppler method.

In order to achieve the object described above, according to this invention, there provided a two-frequency Doppler distance measuring apparatus wherein the spectrum is analyzed as well as the time waveform of the Doppler signal.

In an ideal measurement environment, the Doppler signal has one frequency with a spectrum having a clear peak. In that case, the spectra of the first and second Doppler signals substantially coincide with each other. In the case where the behavior of a reflection object or the shape of the reflection surface is complicated, however, the Doppler signal contains various frequency components with a distorted waveform having a forked peak and a displacement of peak position.

In view of this, according to this invention, all the Doppler signals observed are not used for measuring the distance but the observed waves are selected in accordance with whether the spectra of two observed waves are analogous or not, and the distance is calculated using only the observed waves having analogous spectra. As a result, the accuracy and reliability of distance measurement and detection are improved.

Specifically, according to this invention, there provided a two-frequency Doppler distance measuring apparatus comprising at least a first Doppler measuring device, a second Doppler measuring device, an analogy determining device and a distance calculation device, wherein a first Doppler measuring device acquires a first Doppler signal from the transmission wave of a first frequency and the reflection wave thereof, and a second Doppler measuring device acquires a second Doppler signal from the transmission wave of a second frequency different from the first frequency and the reflection wave thereof, the analogy determining device determines whether the spectrum of the first Doppler signal is analogous to the spectrum of the second Doppler signal, and in the case where it is determined that the spectrum of the first Doppler signal is analogous to the spectrum of the second Doppler signal, the distance calculation device calculates the distance to the reflection object based on the first and second Doppler signals.

Various methods for determining the analogy are conceived as described below.

In one method, the analogy determining device determines the analogy between the spectrum of the first Doppler signal and the spectrum of the second Doppler signal based on the peak values of the spectra of the first and second Doppler signals.

The peak value (amplitude) of the spectrum varies depending on the sectional area of reflection, distance and behavior of the reflection object, and therefore the peak values of the two spectra should be substantially equal to each other for the same object. The higher the peak value (the clearer the peak), the higher the reliability of the phase information of the Doppler signal is considered.

In the case where the peak values of the two spectra are larger than a predetermined threshold and/or the difference between the peak values of the two spectra is smaller than a predetermined threshold, for example, it is determined that the two spectra are analogous to each other. By using the phase information of the Doppler signal involved for distance calculation, the distance measurement accuracy is improved. The threshold can be appropriately set taking the sectional area, distance and behavior of the reflection object and the required distance measurement accuracy and the like into consideration.

Also, the analogy determining device preferably determines the analogy between the spectra of first and second Doppler signals by comparing the peak frequencies of the two spectra.

The peak frequency of the spectrum changes depending on the moving speed of the reflection object. As long as the transmission waves and the reflection waves of two frequencies pass through the same propagation path and catch the same reflection object, therefore, the peak frequencies of the two spectra should coincide with each other. In other words, in the case where the peak frequencies are different, either the propagation path or the reflection object is different.

Thus, in the case where the difference between the peak frequencies of the two spectra is smaller than a predetermined threshold or the peak frequencies of the two spectra substantially coincide with each other, it is determined that the two spectra are analogous to each other. If the phase information of the Doppler signals involved is used for distance calculation, therefore, the distance measurement accuracy can be improved. The threshold is appropriately set taking the reflection object, the propagation path of the wave and the required distance measurement accuracy and the like into consideration.

Other methods of analogy determination, such as a method in which the dispersion values of the two spectra are compared with each other, a method in which the analogy is determined based on the correlation value between the two spectra and a method in which the patterns of the waveforms of the two spectra are matched, or the like can be applied. Nevertheless, any other appropriate methods or a combination of several ones of the methods described above may be used.

The analogy determining device preferably acquire the spectrum of the Doppler signals by the short time Fourier transform (STFT). This makes possible the spectral analysis of the time waveform for a short time, and therefore even in the case where the behavior of the reflection object is complicated, the frequency components contained in the time waveform can be reduced. Thus the reliability of analogy determination and the accuracy of distance calculation are improved.

The two-frequency Doppler distance measuring apparatus described above can accurately measure and detect the distance of an object such as a human body having a complicated behavior and/or reflection surface as well as an object such as a vehicle having a simple behavior and/or reflection surface. Thus, the two-frequency Doppler distance measuring apparatus can be used for various detection systems.

A preferred possible application includes a bathing person detection system comprising a two-frequency Doppler distance measuring apparatus according to the invention and an entry/exit determining device for determining whether a bathing person is entering or leaving a bathroom, based on the distance to the bathing person measured by the two-frequency Doppler distance measuring apparatus.

Once the distance to the bathing person (the reflection object of which the motion is detected) is determined, it can be easily determined whether the particular person is located inside or outside the bathroom. Thus, the operation of monitoring the behavior of the bathing person can be automatically started and ended. In the prior art, the bathing person is instructed to perform switching operations or an occupancy sensor is arranged on the door of the bathroom to control the behavior monitor operation. This has caused problems of the erroneous switching operation and the need of wiring. Such problems are not encountered by the bathing person detection system according to the invention.

The apparatus according to the invention preferably further comprises a behavior detection device for detecting the behavior of the bathing person based on at least one of a first Doppler signal and a second Doppler signal. As a result, the distance measuring function and the behavior detection function can be implemented with the same Doppler measuring device, and therefore the configuration is simplified, a compact system is realized and the cost is reduced.

Another possible application is a position detection system comprising a plurality of two-frequency Doppler distance measuring apparatuses according to the invention and a position calculation device for calculating the two- or three-dimensional position of a reflection object based on the distance measured by each two-frequency Doppler distance measuring apparatus. As long as the interval between a pair of arranged two-frequency Doppler distance measuring apparatuses is known, for example, the two-dimensional position of the reflection object can be calculated by the principle of trigonometrical survey. Similarly, by using three two-frequency Doppler distance measuring apparatuses, the three-dimensional position of the reflection object can be calculated. In this way, a position detection system of a simple configuration capable of detecting the position of an object with high accuracy is realized at low cost.

Still another possible application is a position detecting system comprising a two-frequency Doppler distance measuring apparatus according to the invention, a scan antenna, and a position calculation device for calculating the position of a reflection object based on the distance measured by the two-frequency Doppler distance measuring apparatus and the beam direction of the scan antenna.

This invention may be perceived as a two-frequency Doppler distance measuring apparatus having at least a part of the device described above or a bathing person detection system or a position detection system having the apparatus. Also, this invention may be perceived as a two-frequency Doppler distance measuring method including at least a part of the processes described above or a bathing person detection method or a position detection method including the particular distance measuring method. The device and processes described above can be combined as variously as possible to configure this invention.

According to this invention, the distance of an object such as a human body having a complicated behavior and/or reflection surface can be measured and detected with high accuracy using the two-frequency Doppler method. In this way, the applications of the two-frequency Doppler distance measuring apparatus are widened.

### BRIEF DESCRIPTION OF THE DRAWINGS

FIG. 1 shows a block diagram of the configuration of a two-frequency Doppler distance measuring apparatus according to an embodiment of the invention.

FIG. 2 shows a block diagram of a modification of the two-frequency Doppler distance measuring apparatus.

FIG. 3 shows a flowchart of the process flow of a signal processing unit.

FIG. 4 shows a frequency waveform of the spectrum of the two-frequency Doppler signal.

FIG. 5 shows a time waveform for explaining a phase-inverted portion appearing in the Doppler signal.

FIG. 6 shows a schematic diagram for explaining a multipath environment.

FIG. 7 shows a frequency waveform of an example in which a spectral peak appears in a different frequency.

FIG. 8 shows a schematic diagram for explaining an example setting of the threshold of the peak frequency difference of the spectrum.

FIG. 9 shows a diagram of an installation example of the conventional behavior monitor sensor (switch type).

FIG. 10 shows a diagram of an installation example of the conventional behavior monitor sensor (occupancy sensor type).

FIG. 11 shows a diagram of an installation example of the behavior monitor sensor according to an embodiment of the invention.

FIG. 12 shows a diagram of a configuration of a position detection system according to an embodiment of the invention.

FIG. 13 shows a diagram of a configuration of a position detection system according to an embodiment of the invention.

FIG. 14 shows a time waveform of the two-frequency Doppler signal obtained in an ideal measurement environment.

FIG. 15 shows a time waveform of the two-frequency Doppler signal observed for an object having a simple behavior/reflection surface.

FIG. 16 shows a time waveform of the two-frequency Doppler signal observed for an object having a complicated behavior/reflection surface.

### DESCRIPTION OF THE PREFERRED EMBODIMENTS

Preferred embodiments of the invention are illustratively explained in detail below with reference to the drawings.

(Two-Frequency Doppler Distance Measuring Apparatus)

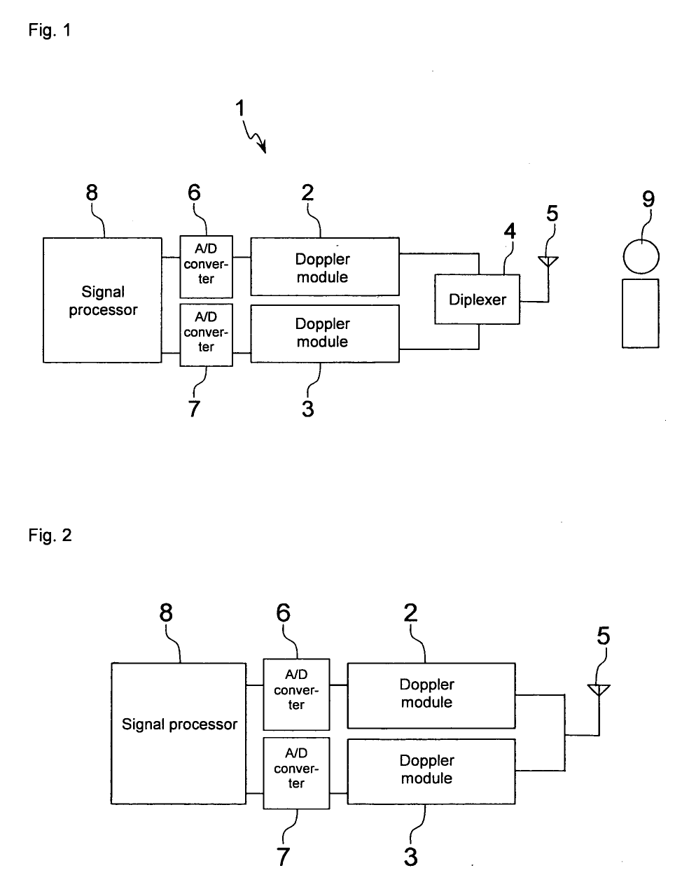

FIG. 1 is a block diagram showing a configuration of the two-frequency Doppler distance measuring apparatus according to an embodiment of the invention.

This two-frequency Doppler distance measuring apparatus 1 comprises two Doppler modules 2, 3, a diplexer 4, an antenna 5, A/D converters 6, 7, and a signal processing unit 8.

The Doppler module 2 is a first Doppler measuring device for producing a first Doppler signal from the transmission wave of a first frequency ft1 and the reflection wave thereof.

The Doppler module 2 generates a transmission wave composed of a continuous wave such as a sine wave. This transmission wave is radiated from the transmission/receiving antenna 5 through the diplexer 4. The reflection wave reflected on a reflection object 9 is received by the antenna 5, and through the diplexer 4, input to the Doppler module 2. The Doppler module 2 generates a first Doppler signal representing the frequency difference between the transmission wave and the reflection wave (received wave). This Doppler signal, after being amplified, is input to the signal processing unit 8 through the A/D converter 6.

The Doppler module 3 is a second Doppler measuring device for producing a second Doppler signal from the transmission wave of a second frequency ft2 and the reflection wave thereof. The Doppler modules 2 and 3 have the same configuration except the case where the first frequency ft1 and the second frequency ft2 are different. According to this embodiment, a microwave of 10 GHz band is used and the difference between the frequencies ft1 and ft2 is set to several tens of MHz.

The diplexer 4 is a frequency separator for preventing the transmission wave or the reflection wave having different frequencies from leaking into the Doppler module 2 or 3. In this way, the two Doppler modules 2, 3 share the antenna 5.

In the case where the difference between the frequencies ft1 and ft2 is sufficiently large as compared with the frequency of the Doppler signals, however, the Doppler signals are not affected substantially even if the signal of one module leaks into the other module. In this case, the diplexer may be detached as shown in FIG. 2.

The signal processing unit 8 is a circuit for digital signal processing in accordance with a program. The signal processing unit 8 mainly executes the process of analyzing the spectrum of the two-frequency Doppler signals input from the Doppler modules 2, 3 and the process of calculating the distance to the reflection object 9 based on the two Doppler signals. These processes are described in detail below.

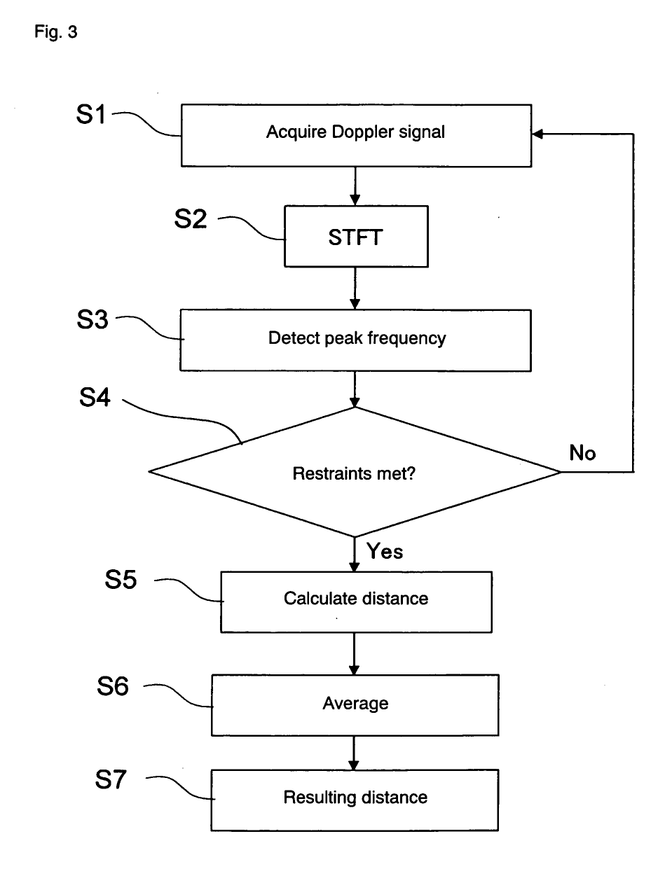

FIG. 3 is a flowchart showing the flow of the processes executed by the signal processing unit 8.

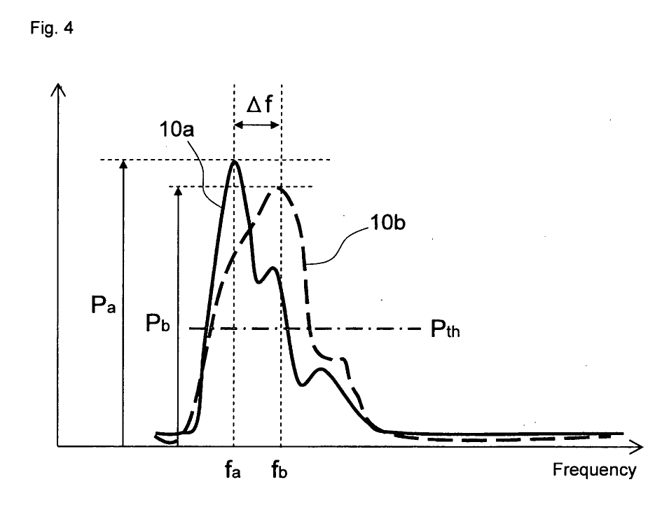

The signal processing unit 8, upon acquisition of the time waveform of the Doppler signals from the Doppler modules 2, 3 (step S1), generates the spectra 10a, 10b (FIG. 4) of the Doppler signals by the short time Fourier transform (STFT) (step S2). The use of STFT makes possible the short time waveform spectrum analysis. Even in the case where the behavior of the reflection object is complicated, therefore, the frequency components contained in the time waveform can be reduced, thereby making it possible to improve the reliability of subsequent analogy determination. Especially, the motion of a human body varies greatly in a short time, and therefore in the case where a human body is an object of distance measurement, a short time window of about 0.25 to 0.5 seconds is preferably used.

Then, the signal processing unit 8 determines whether the spectrum 10a of the first Doppler signal and the spectrum 10b of the second Doppler signal are analogous to each other or not. According to this embodiment, the analogy between the waveforms of the two spectra 10a, 10b is determined based on the peak values and the peak frequencies.

First, the signal processing unit 8 detects the peak frequencies fa, fb of the spectra 10a, 10b (step S3). As a method of peak detection, the frequency associated with the maximum amplitude of the spectrum is selected as a peak frequency, or the peak frequency is selected based on the center of gravity or dispersion of the spectrum waveform.

The signal processing unit 8 then acquires the peak values Pa, Pb of the spectra 10a, 10b, calculates the peak frequency difference Δf(=|fa−fb|) and checks whether the peak values Pa, Pb and the peak frequency difference Δf satisfy the two restraints described below at the same time thereby to determine the spectrum analogy (step S4).
Restraint 1: peak values Pa, Pb>threshold Pth
Restraint 2: peak frequency difference Δf<threshold fth.

The restraint 1 is to determine that two spectra 10a, 10b are analogous to each other in the case where the peak values Pa, Pb of the spectra are both larger than the predetermined threshold Pth. This is based on the fact that in the case where each Doppler signal reflects the behavior of the same object correctly, the peak values Pa, Pb of the two spectra 10a, 10b are substantially equal to each other.

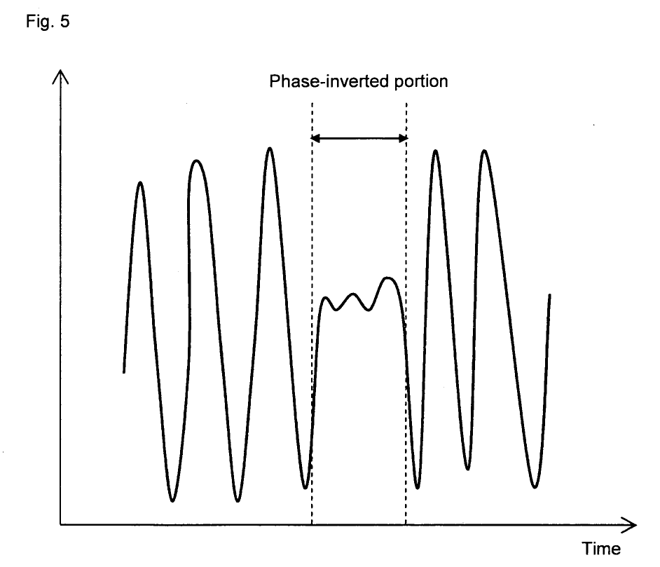

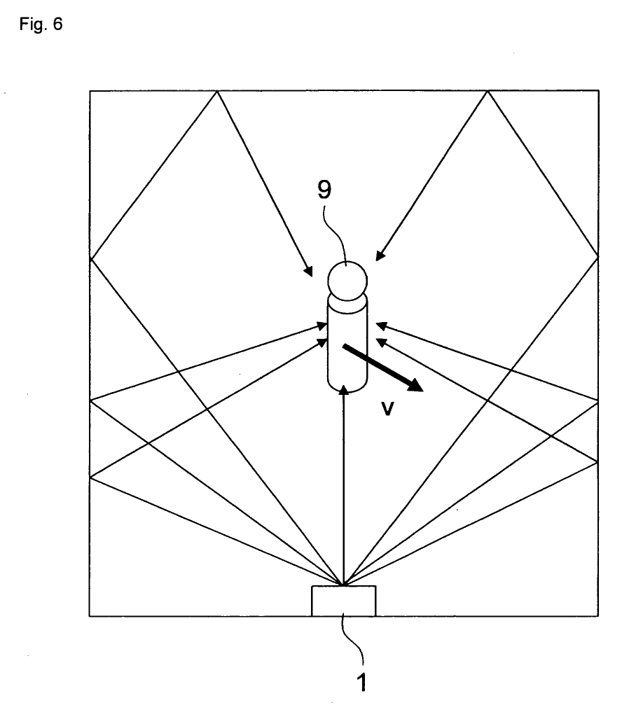

The conditions for determination are set based on the threshold Pth according to this embodiment for the reason described below. Specifically, in the case where a human body is in a back-and-forth vibratory motion, for example, a phase-inverted portion as shown in FIG. 5 appears in the time waveform of the Doppler signal when the direction of motion is changed (from front to back or from back to front). At this phase-inverted portion, the S/N ratio is reduced compared to the other portions, resulting in a reduced reliability of the phase information. This waveform, therefore, is not suitable for distance measurement. At this phase-inverted portion, on the other hand, the spectrum forms no significant peak and the peak value is reduced in level. By setting the condition that the peak value of the spectrum is required to exceed the threshold Pth, therefore, the Doppler waveform such as the phase-inverted portion low in reliability can be eliminated and the accuracy of the distance measurement improved.

The restraint 2 is to determine that the two spectra 10a, 10b are analogous to each other in the case where the difference Δf between the peak frequencies thereof is smaller than a predetermined threshold fth. This is based on the fact that the peak frequencies fa, fb of the two spectra 10a, 10b become substantially equal to each other in the case where the two-frequency transmission wave and the reflection wave pass through the same propagation path and catch the same object, as described in detail below.

As shown in FIG. 6, in a room surrounded by walls or a place with reflection objects scattered around, the propagation paths of the radio wave between the two-frequency Doppler distance measuring apparatus 1 and the reflection object 9 include, other than linear direct paths, a plurality of paths reaching the target reflection object 9 after being reflected on the walls and the reflective items.

A consideration of the use of the two-frequency Doppler distance measuring apparatus 1 in this multipath environment is made. Radio waves of two channels (ch1, ch2) having different frequencies are transmitted from the antenna 5 of the two-frequency Doppler distance measuring apparatus 1, and the reflection waves passed through each of the paths and reflected on the reflection object 9 are received by the antenna 5. These received waves are combined into synthetic reflection wave of all the paths. Since the length of each path is different, the waves in same phase are strengthened by each other or the waves in different phases are weakened by each other.

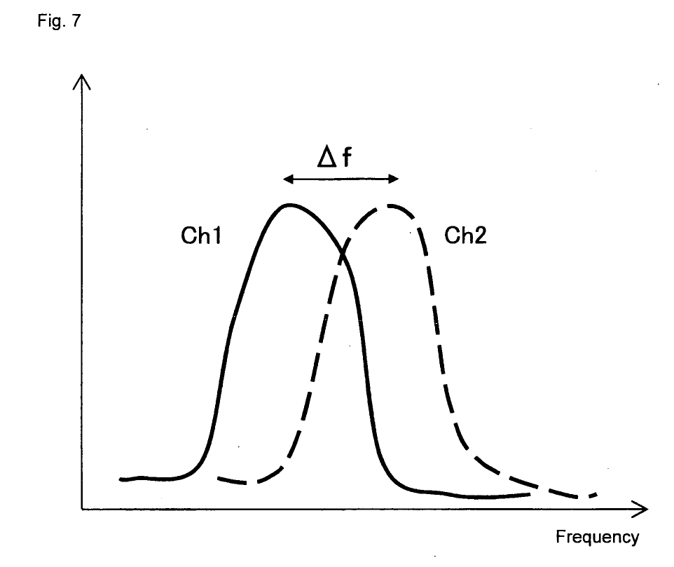

The radio waves of ch1 and ch2 have different frequencies, and therefore are not always combined into the same reflection wave. Depending on the position and motion of the reflection object 9, therefore, the spectral peak of each channel appears at a different frequency as shown in FIG. 7.

The fact that the Doppler signal obtained in each channel has a different frequency is indicative of the fact that the reflection object 9 is detected at a different rate in each channel. Specifically, the reflection object 9 is viewed not from the same direction but different directions and detected by different paths. The distance calculated based on these Doppler signals cannot be an accurate measurement.

According to this embodiment, in the case where the difference Δf between the peak frequencies fa and fb of the two channels in a spectral waveform is larger than a predetermined threshold fth, the Doppler signal corresponding to the particular portion is eliminated to improve the accuracy of the distance measurement.

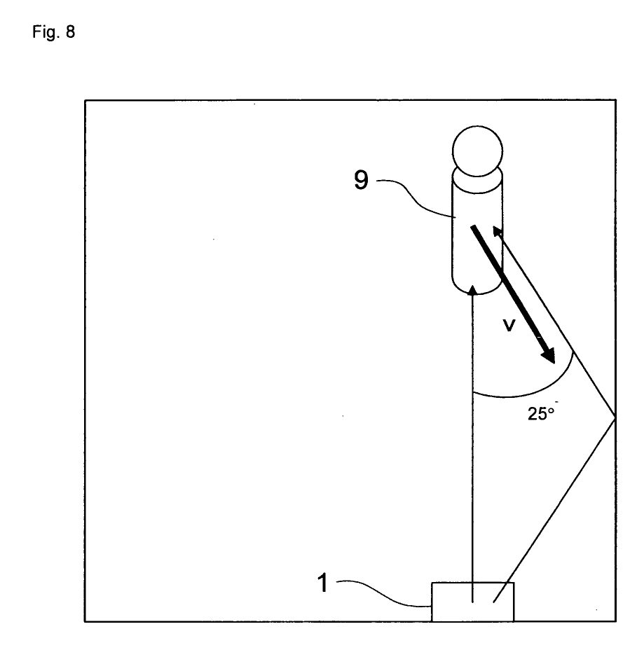

The threshold fth is appropriately set in accordance with the required accuracy of distance measurement. According to this embodiment, for example, as shown in FIG. 8, in order to meet the accuracy requirement that the angle between the paths of the two channels is 25 degrees or less, i.e. the distance difference (rate difference) is about 10% or less, the threshold fth is set to about 10% of the peak frequency fa.

In the case where the spectra 10a, 10b fail to meet the restraints 1, 2 at the same time, the signal processing unit 8 discards the Doppler signal in the particular time window and, returning to step S1, acquires the Doppler signal of the next time window.

In the case where both the restraints are met, on the other hand, the signal processing unit 8 calculates the distance to the reflection object 9 based on the phase difference of the Doppler signals in the particular time window (step S5). By calculating the distance based on the Doppler signals of a short time window, the number of the frequency components contained in the time waveform can be reduced with an improved basic accuracy of distance calculation. The result of this calculation is stored in a memory temporarily.

The signal processing unit 8, after calculation of the distance in a plurality of time windows, averages the results of the calculations (step S6) and determines the distance to the reflection object 9 (step S7). This averaging operation improves the S/N ratio.

According to this embodiment described above, the distance is calculated using only the Doppler signals having similar spectra, and therefore the high-accuracy distance measurement and detection are possible also for an object like a human body behaving in a complicated way and/or having a complicated reflection surface as well as an object like a vehicle simple in both behavior and reflection surface.

As a result, the two-frequency Doppler distance measuring apparatus 1 according to this embodiment is applicable to various detection systems. Some applications are described below.

(Bathing Person Detection System)

A bathing person detection system installed in a bathroom (hereinafter referred to as “the behavior monitor sensor”) is for protecting the bathing person from an accident by monitoring his/her behavior in the bathroom. The behavior monitor sensor determines an abnormal condition by detecting the bathing person in stationary state. If the behavior monitor sensor is kept on, however, an alarm may be issued in the absence of a bathing person or otherwise an erroneous alarm may be caused.

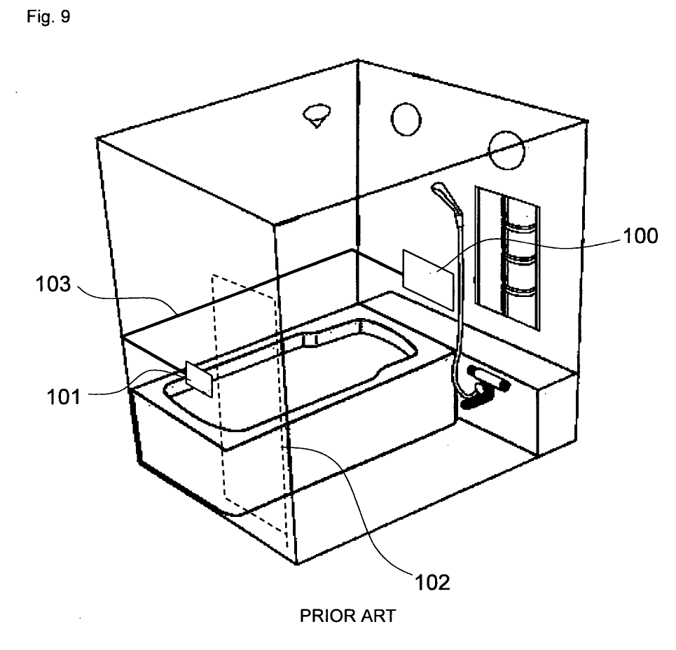

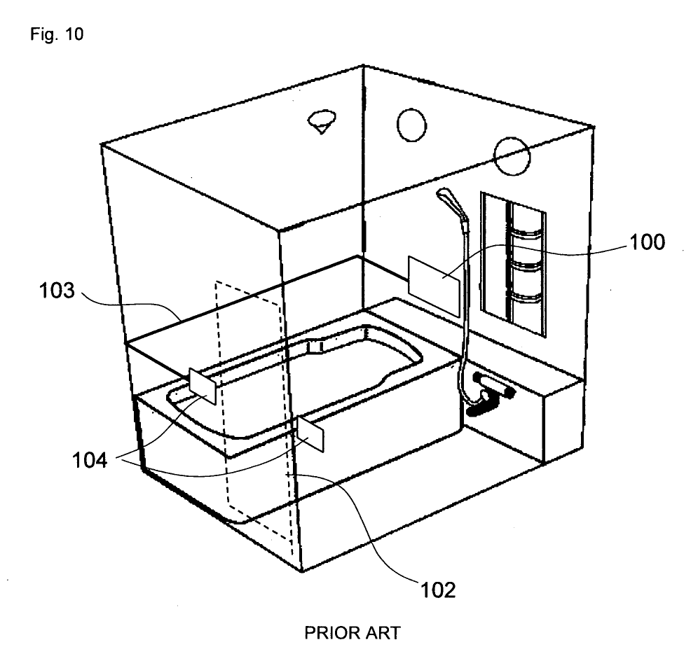

To prevent this inconvenience, according to the prior art, as shown in FIG. 9, a switch 101 is arranged at the entrance of the bathroom 102 for the bathing person himself to turn on/off the behavior monitor sensor 100, or as shown in FIG. 10, an occupancy sensor 104 is arranged at the entrance to detect the entry and exit of the bathing person (Japanese Unexamined Patent Publication No. 2002-312815).

The former system causes the problem of an operation error such as the switch 101 being inadvertently left on, and the latter system the problem of a high cost due to the use of a plurality of sensors. In both systems, the wiring 103 is required to be laid between the behavior monitor sensor 100 and the switch 101 or the occupancy sensor 104, resulting in a low workability.

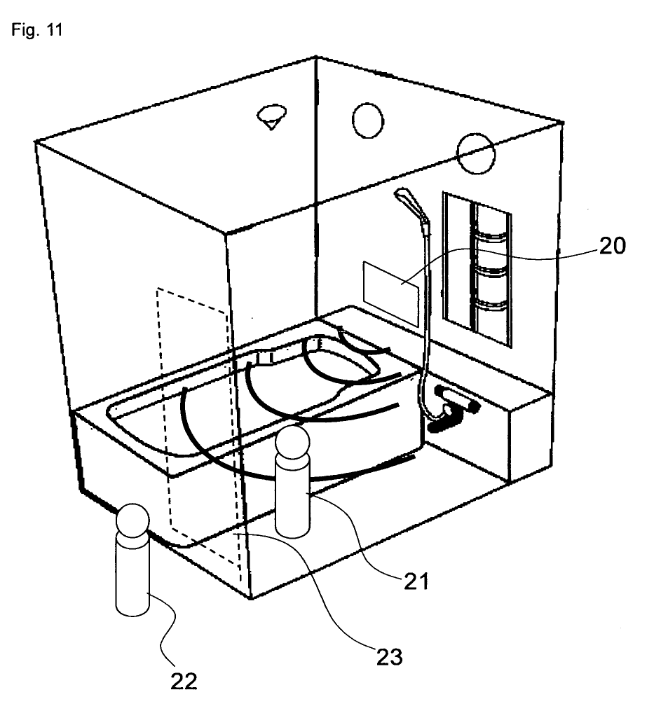

To obviate these problems, according to this embodiment, the two-frequency Doppler distance measuring apparatus 1 is used as a behavior monitor sensor. FIG. 11 shows an example installation of the behavior monitor sensor.

The behavior monitor sensor 20 includes a distance detector configured of a two-frequency Doppler distance measuring apparatus 1 and an entry/exit determining unit for determining whether a bathing person has entered or left the bathroom, based on the distance to the bathing person detected by the distance detector. Also, the behavior monitor sensor 20 includes a behavior detector for detecting the behavior of the bathing person. The entry/exit determining unit and the behavior detector are both the functions that can be implemented by the signal processing unit 8 shown in FIG. 1.

The distance detector is kept on. When a moving object (such as a bathing person) enters a range covered by the radio wave, the Doppler signals are detected, and the distance detector calculates the distance to the moving object by the two-frequency Doppler distance measurement method described above.

Then, the entry/exit determining unit compares the distance to the moving object with the distance between the behavior monitor sensor 20 and the door 23 (hereinafter referred to as “the monitor distance”) and determines whether the moving object is in or out of the bathroom. The monitor distance is a preset value stored in the memory of the behavior monitor sensor 20. In the case where the moving object exists in the bathroom, the entry/exit determining unit starts the monitor operation of the behavior detector. The behavior detector detects the behavior of the bathing person 21 by use of one of the two Doppler signals detected by the two-frequency Doppler distance measuring apparatus 1.

Specifically, in the case where the bathing person 22 is located outside of the bathroom, the monitor operation is off, while the bathing person 21 enters the bathroom by opening the door 23, the monitor operation is automatically turned on. As long as the bathing person 21 stays in the bathroom (within the range of not more than the monitor distance), the monitor operation is continued by the behavior detector, while in the case where the behavior of the bathing person 21 fails to be detected for a predetermined length of time, an abnormal condition is determined and an alarm is issued or a buzzer is sounded.

In the case where the distance to the bathing person 21 progressively increases and exceeds the monitor distance, the entry/exit determining unit determines that the bathing person has left the bathroom and turns off the monitor operation of the behavior detector.

The behavior monitor sensor 20 described above has the function of measuring the distance by the two-frequency Doppler system, and therefore it is easily determined whether the bathing person is located in or outside of the bathroom, and the operation of monitoring the bathing person can be automatically turned on/off. Thus, the problem of erroneous operation or alarm is obviated and the reliability of monitoring the behavior of the bathing person is improved.

Also, since the switch and the occupancy sensor become unnecessary, the wiring is not required. Thus, the workability is improved and the appearance of the bathroom is not adversely affected.

Further, the distance measuring function (entry/exit monitor function) and the behavior detection function are implemented by use of the same Doppler module. Therefore, the configuration is simplified and the system reduced in size and cost.

Furthermore, the chance of an erroneous alarm being issued is reduced by removing the disturbances external to the bathroom at the time of behavior detection.

(Example 1 of Position Detection System)

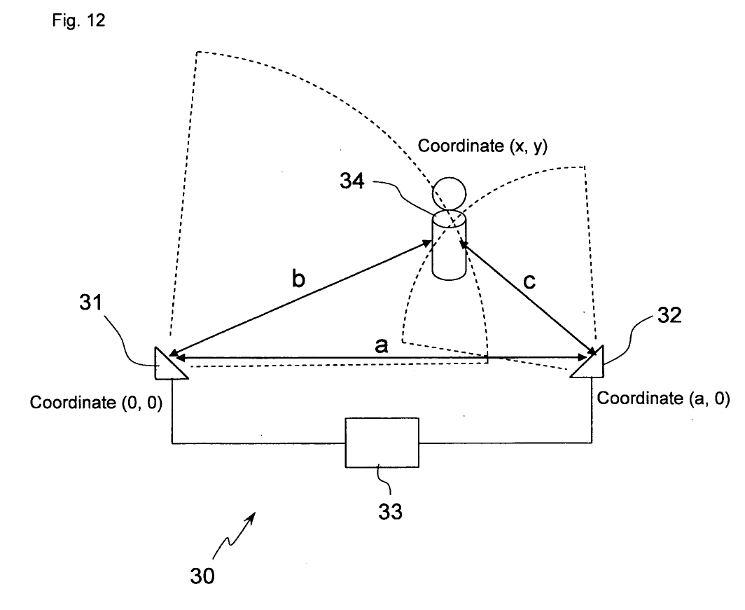

FIG. 12 shows a position detection system using the two-frequency. Doppler distance measuring apparatus described above.

The position detection system 30 comprises a first two-frequency Doppler distance measuring apparatus 31, a second two-frequency Doppler distance measuring apparatus 32 and a position calculation unit 33. The two-frequency Doppler distance measuring apparatuses 31, 32 are arranged at an interval a with the antenna directivity thereof set in such a manner that the respective distance measurement areas intersect each other. The intersection of the distance measurement areas represents the detection area of the moving object.

When a moving object (intruder 34) enters the detection area, the two-frequency Doppler distance measuring apparatuses 31, 32 detect the Doppler signals and measure the distance to the intruder 34. These distance measurements are input to a position calculation unit 33.

The position calculation unit 33 calculates the two-dimensional position of the intruder 34 from the distance measurements. As shown in FIG. 12, let b be the distance measured by the first two-frequency Doppler distance measuring apparatus 31 and c be the distance measured by the second two-frequency Doppler distance measuring apparatus 32. The two-dimensional position (x, y) of the intruder 34 is calculated by the following equations:

$$\begin{matrix}x = \frac{{a}^{2} + {b}^{2} - {c}^{2}}{2 a} \\ y = \sqrt{{b}^{2} - \frac{{( {a}^{2} + {b}^{2} - {c}^{2} )}^{2}}{4 {a}^{2}}}\end{matrix} \qquad ( 2 )$$

By repeating this position detect operation, the traffic line of the intruder 34 can be detected.

This position detection system 30 is suitably used for the security sensor, for example. In a conceivable application, the position detection system 30 is installed in the path of intrusion into a building monitored and the traffic line of the intruder is detected. In this way, when the intruder makes an approach through a predetermined path, an alarm is issued or an external equipment or security center is informed.

The configuration described above can realize a position detection system simple in configuration capable of high-accuracy position detection at low cost.

Instead of the pair of the two two-frequency Doppler distance measuring apparatuses used for detecting the two-dimensional position of a moving object as described above, three or more two-frequency Doppler distance measuring apparatuses may be combined to detect a three-dimensional position of the moving object.

(Example 2 of Position Detection System)

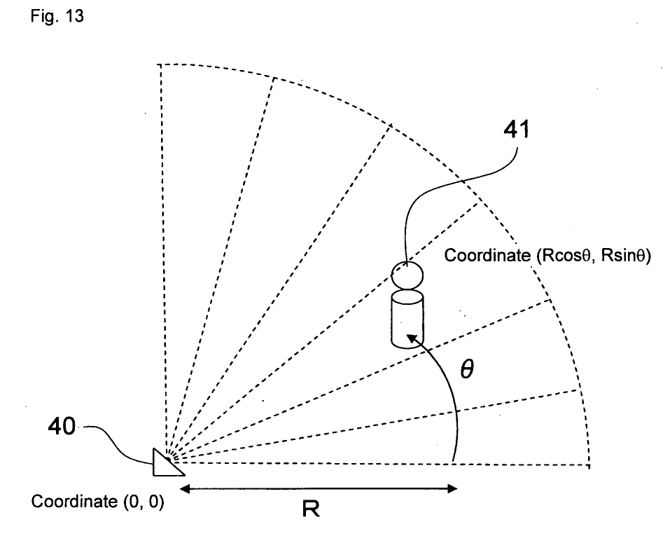

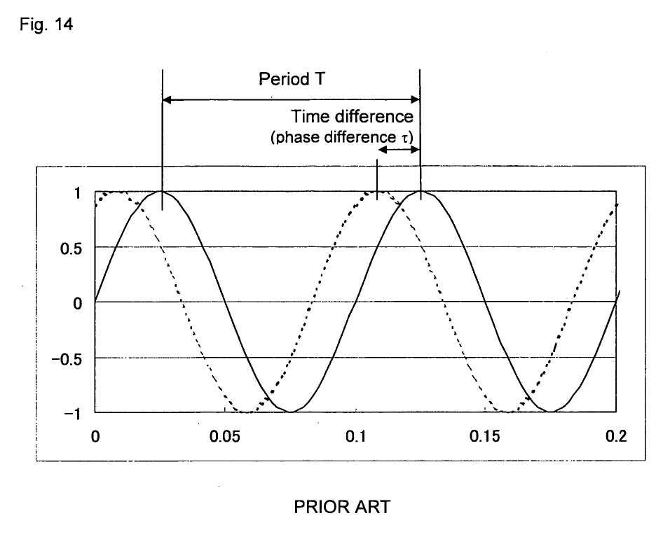

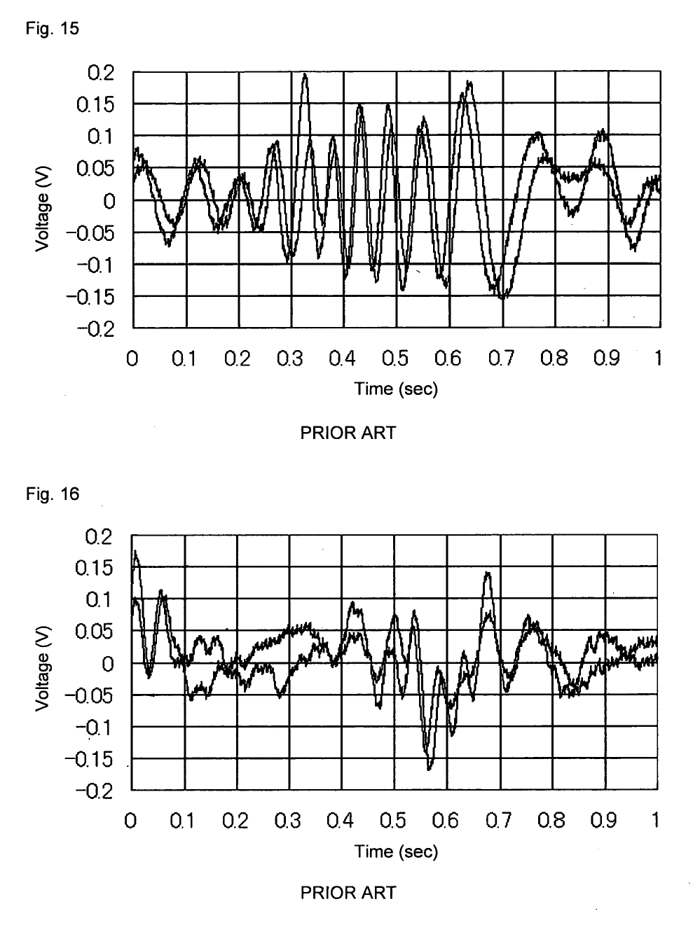

FIG. 13 shows a position detection system employing the two-frequency Doppler distance measuring apparatus described above.

The position detection system 40 comprises a scan antenna and scans the monitor area by sequentially switching the direction of beam radiation. The two-frequency Doppler distance measuring apparatus measures the distance in each beam direction. When a moving object (intruder 41) enters the monitor area, the two-frequency Doppler distance measuring apparatus detects the Doppler signals thereby to measure the distance to the intruder 41. The position calculation unit of the position detection system 40 calculates the two-dimensional position of the intruder 41 based on the distance measurement and the direction of the radiated beam.

By repeating this position detect operation, the traffic line of the intruder 41 can be detected. This position detection system 40, like the position detection system 30 shown in FIG. 12, is also suitably used for a security sensor or the like.

The embodiments described above illustrates only specific examples of the invention. The invention is therefore is not limited to the aforementioned embodiments, and variously modifiable within the scope of the technical concept thereof.

1. A two-frequency Doppler distance measuring apparatus comprising:
a first Doppler measuring device for producing a first Doppler signal from the transmission wave of a first frequency and the reflection wave thereof;
a second Doppler measuring device for producing a second Doppler signal from the transmission wave of a second frequency different from the first frequency and the reflection wave thereof;
an analogy determining device for determining whether the spectrum of the first Doppler signal and the spectrum of the second Doppler signal are analogous to each other or not; and
a distance calculation device for calculating the distance to a reflection object based on the first and second Doppler signals in the case where the spectra of the first and second Doppler signals are determined as analogous to each other.

2. A two-frequency Doppler distance measuring apparatus according to claim 1,
wherein the analogy determining device determines the analogy between the spectrum of the first Doppler signal and the spectrum of the second Doppler signal based on the peak values of the two spectra.

3. A two-frequency Doppler distance measuring apparatus according to claim 1,
wherein the analogy determining device determines the analogy between the spectrum of the first Doppler signal and the spectrum of the second Doppler signal by comparing the peak frequencies of the spectra with each other.

4. A two-frequency Doppler distance measuring apparatus according to claim 1,
wherein the analogy determining device produces the spectra of the Doppler signals by the short time Fourier transform.

5. A two-frequency Doppler distance measuring method comprising the steps of:
acquiring a first Doppler signal from the transmission wave of a first frequency and the reflection wave thereof;
acquiring a second Doppler signal from the transmission wave of a second frequency different from the first frequency and the reflection wave thereof;
determining whether the spectrum of the first Doppler signal and the spectrum of the second Doppler signal are analogous to each other or not; and
calculating the distance to a reflection object based on the first and second Doppler signals in the case where the spectra of the first and second Doppler signals are determined as analogous to each other.

6. A bathing person detection system comprising:
a two-frequency Doppler distance measuring apparatus according to claim 1; and
an entry/exit determining device for determining whether a bathing person has entered or exited from a bathroom based on the distance to the bathing person measured by the two-frequency Doppler distance measuring apparatus.

7. A bathing person detection system according to claim 6, further comprising:
a behavior detection device for detecting the behavior of the bathing person based on at least one of the first Doppler signal and the second Doppler signal.

8. A position detection system comprising a plurality of the two-frequency Doppler distance measuring apparatuses according to claim 1, and a position calculation device for calculating selected one of the two-dimensional position and the three-dimensional position of a reflection object based on the distance measured by each of the two-frequency Doppler distance measuring apparatuses.

9. A two-frequency Doppler distance measuring apparatus according to claim 2,
wherein the analogy determining device determines the analogy between the spectrum of the first Doppler signal and the spectrum of the second Doppler signal by comparing the peak frequencies of the spectra with each other.

10. A two-frequency Doppler distance measuring apparatus according to claim 2,
wherein the analogy determining device produces the spectra of the Doppler signals by the short time Fourier transform.

11. A two-frequency Doppler distance measuring apparatus according to claim 3,
wherein the analogy determining device produces the spectra of the Doppler signals by the short time Fourier transform.

12. A position detection system comprising a plurality of the two-frequency Doppler distance measuring apparatuses according to claim 2, and a position calculation device for calculating selected one of the two-dimensional position and the three-dimensional position of a reflection object based on the distance measured by each of the two-frequency Doppler distance measuring apparatuses.

13. A position detection system comprising a plurality of the two-frequency Doppler distance measuring apparatuses according to claim 3, and a position calculation device for calculating selected one of the two-dimensional position and the three-dimensional position of a reflection object based on the distance measured by each of the two-frequency Doppler distance measuring apparatuses.

14. A position detection system comprising a plurality of the two-frequency Doppler distance measuring apparatuses according to claim 4, and a position calculation device for calculating selected one of the two-dimensional position and the three-dimensional position of a reflection object based on the distance measured by each of the two-frequency Doppler distance measuring apparatuses.
